(19) United States
(12) Patent Application Publication
(10) Pub. No.: US 2002/0176410 A1
(43) Pub. Date: Nov. 28, 2002

(54) Time-slot interchange switches having automatic frame alignment measurement and programming capability

(76) Inventors: Dave MacAdam, Atlanta, GA (US); Alex Goldhammer, San Francisco, CA (US)

Correspondence Address: MYERS BIGEL SIBLEY & SAJOVEC, PO BOX 37428, RALEIGH, NC, 27627, US

(21) Appl. No.: 09/858,410

(22) Filed: May 16, 2001

(51) Int. Cl. H04Q 11/00; H04J 3/06

(52) U.S. Cl. 370/376; 370/517

(57) ABSTRACT

Time-slot interchange switches include measurement circuits that automatically measure frame alignment associated with a plurality of multi-frame data streams received by the switch. Internal programming circuits are also provided to convert the frame alignment measurements into frame offsets. Unacceptable frame offsets are also automatically identified using error control circuitry. These measurement and programming circuits streamline frame offset measurement techniques and enable on-chip measurement and conversion of frame delays to frame offsets and programming of frame offset registers (FORs).

### FIELD OF THE INVENTION

The present invention relates to integrated circuit devices and methods of operating same, and more particularly to integrated circuit switches that receive and transmit serial data streams and methods of operating same.

### BACKGROUND OF THE INVENTION

Conventional time-slot interchange switches enable manual measurement of frame offsets associated with a plurality of multi-frame data streams received by the switches. As illustrated by the conventional switch 10 of FIG. 1, an internal frame alignment counter 12, an internal frame alignment register 14 and an internal frame offset register 18 may be provided to facilitate measurement of frame offsets. External circuitry, provided by a user, may also facilitate manual measurement and may include delay limit check circuitry 20, offset conversion circuitry 16, temporary register write control circuitry 22 and a temporary register 24.

As illustrated, the internal frame alignment counter 12 is responsive to a frame evaluation signal (FE), a frame output indicator signal (FOi), an external clock signal (CLK) and a start frame evaluation signal (SFE). The conventional methodology for manually programming the switch 10 of FIG. 1 with frame offsets involves a number of separate steps, and may require off-chip data conversion and storage. The programming operations commence by setting the start frame evaluation signal (SFE) low for at least one frame of a stream being evaluated and then switching SFE high. At this point, the frame alignment counter 12 is aligned to the FOi signal, and stops counting once the frame evaluation signal (FE) is received. The value of the counter 12, which identifies the number of clock pulses between FOi and FE, as well as a bit indicating the phase of the external clock (CLK) when FE transitioned, are then loaded into the frame alignment register (FAR) 14. The value from the counter 12 may constitute a multi-bit count signal CNT<X:0>. Two or more frames later, once the complete frame evaluation (CFE) bit (not shown) goes high, a valid frame delay measurement is ready to be read out of the FAR 14. The user then reads out the count signal and may use conventional delay limit check circuitry 20 to determine whether the frame delay for a given multi-frame data stream exceeds the rating of the switch, which is shown as 4.5 clock cycles. The user may then take corrective action to reduce the frame delay associated with one or more external streams being provided to the switch 10.

Offset conversion circuitry 16 may also be used to convert three bits of delay information (FD<2:0>) and one phase bit into a four bit frame offset (OF<2:0>, DLE). A conventional bit swapping operation may be performed during the conversion process. Temporary register write control circuitry 22 is provided for writing groups of four frame offset bits into a temporary register 24. These groups of frame offset bits may then be provided as program data to the internal frame offset register 18 within the switch 10. The internal frame offset register 18 may have multiple rows of storage units therein, with each row having a width sufficient to maintain multiple frame offsets.

Notwithstanding conventional techniques to measure frame alignment associated with multi-frame serial data streams, which require user intervention and external circuitry, it would be preferable to provide frame alignment measurement and programming operations that are more highly automated.

### SUMMARY OF THE INVENTION

Time-slot interchange switches according to embodiments of the present invention include measurement circuits that automatically measure frame alignment associated with a plurality of multi-frame data streams received by the switch. Internal programming circuits are also provided to convert the frame alignment measurements into frame offsets. Unacceptable frame offsets are also automatically identified using error control circuitry. These measurement and programming circuits streamline frame offset measurement techniques and enable on-chip measurement and conversion of frame delays to frame offsets and programming of frame offset registers (FORs).

According to a first embodiment of the present invention, a preferred time-slot interchange switch includes an internal frame alignment measurement and programming circuit that determines a first frame offset associated with a first multi-frame data stream received by said switch and then stores the first frame offset in a frame offset register. This circuit also at least temporarily retains data that identifies presence of an error in the internal frame offset register. This data may be user accessible data retained by an error code register and the error may constitute an unacceptable frame offset. The internal frame alignment measurement and programming circuit preferably comprises an internal frame alignment counter that determines a first frame delay associated with the first multi-frame data stream. This first frame delay may be determined as a plurality of bits of data that identify the degree to which the first multi-frame data stream is delayed relative to a frame pulse. An internal frame delay conversion circuit is also provided that converts the first frame delay into the first frame offset. According to a preferred aspect of this first embodiment, the frame offset register retains the first frame offset at a first location therein and the error code register retains a pointer having a value that indicates whether an unacceptable frame offset is present at the first location. In particular, the frame offset register may retain M rows of frame offset data with N bytes of frame offset data per row and the error code register may retain an M-bit error code. Each bit of the M-bit error code can be used to identify whether at least one of the N frame offset bytes at a corresponding row in the frame offset register is an unacceptable frame offset.

According to another preferred aspect of this embodiment, the internal frame alignment counter is responsive to a clock signal and generates an error signal if the first frame delay is not less than a threshold number of cycles of the clock signal. A temporary register is also provided that receives acceptable frame offsets from the internal frame delay conversion circuit. An error control circuit is provided that can write an unacceptable frame offset into the temporary register. This error control circuit is preferably responsive to the error signal. The error control circuit also generates the data that is stored by the error code register. A frame offset register control circuit is also provided that writes the unacceptable frame offset and the acceptable frame offsets from the temporary register into the frame offset register.

According to a second embodiment of the present invention, a preferred time-slot interchange switch includes an internal frame alignment measurement and programming circuit that determines and then stores a plurality of acceptable frame offsets associated with a first plurality of multi-frame data streams received by said switch, and determines and then stores an unacceptable frame offset associated with a multi-frame data stream having an offset that exceeds a maximum offset rating of said switch. The acceptable and unacceptable frame offsets are preferably stored within a frame offset register. The internal frame alignment measurement and programming circuit also retains user accessible data that identifies presence of the unacceptable frame offset in the internal frame offset register.

According to a third embodiment of the present invention, a time-slot interchange switch includes first and second storage devices. The first storage device is disposed internal to the switch and retains frame delay/offset bytes, with each of the frame offset/delay bytes identifying a frame delay or frame offset associated with a respective multi-frame data stream received by the switch. The second storage device is also disposed internal to the switch and at least temporarily retains data that identifies presence of an unacceptable frame delay/offset within the first storage device. This data identifies presence and location of the unacceptable frame delay/offset within said first storage device. The first storage device may constitute a register having M rows of storage units therein and the second storage device may retain an M-bit error code therein. Each bit of the error code is preferably accessible by a user to determine whether any of the frame delay/offsets within a respective row of storage units in the first storage device are unacceptable.

According to a fourth embodiment of the present invention, a preferred time-slot interchange switch may include a frame alignment counter that determines a respective frame delay for each of a plurality of multi-frame data streams received by the switch. The frame alignment counter also generates an error signal if any of the frame delays is excessive. A frame delay conversion circuit is also provided to convert the frame delays to respective acceptable frame offsets. Error control circuitry is provided. The error control circuitry is responsive to the error signal and generates an error code and one or more unacceptable frame offsets, depending on the number of data streams having excessive frame delays. A temporary register is provided that stores the acceptable frame offsets and any unacceptable frame offsets received from the frame delay conversion circuit and the error control circuit, respectively. A write control circuit is also provided that writes the acceptable frame offsets and any unacceptable frame offsets from the temporary register to a row within a frame offset register.

### BRIEF DESCRIPTION OF THE DRAWINGS

FIG. 1 is a block diagram that illustrates a conventional method of programming a frame offset register of a time-slot interchange switch.

FIG. 2 is a table that illustrates a conventional relationship between frame delay bits and frame offset bits.

FIG. 3 is a block diagram of a time-slot interchange switch according to a first embodiment of the present invention.

FIG. 4 illustrates a relationship between an error code bit sequence within an error code register and a programmed frame offset register having acceptable and unacceptable frame offsets therein.

FIG. 5 is a block diagram of a time-slot interchange switch according to a second embodiment of the present invention.

FIG. 6 is a block diagram of a time-slot interchange switch according to a third embodiment of the present invention.

FIG. 7 is a block diagram of a time-slot interchange switching according to a fourth embodiment of the present invention.

FIG. 8 is a table that illustrates a relationship between frame delay bits and frame offset bits, for a switch capable of handling a maximum input stream offset of 7.5 clock periods.

### DESCRIPTION OF PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Signal lines and signals thereon may be referred to by the same reference characters. Like numbers refer to like elements throughout. Numeric values for various components of the preferred embodiments are also provided for purposes of illustration only and should not be used to limit the scope of the illustrated embodiments or claims.

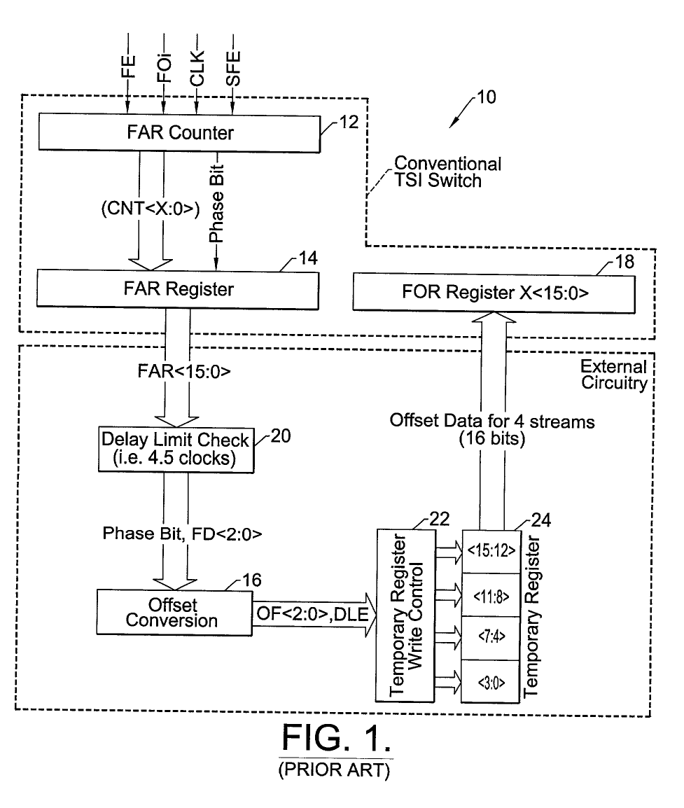

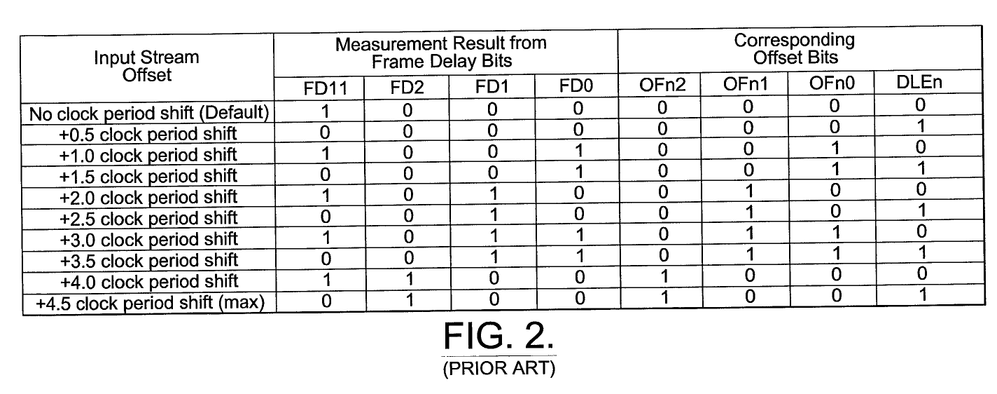

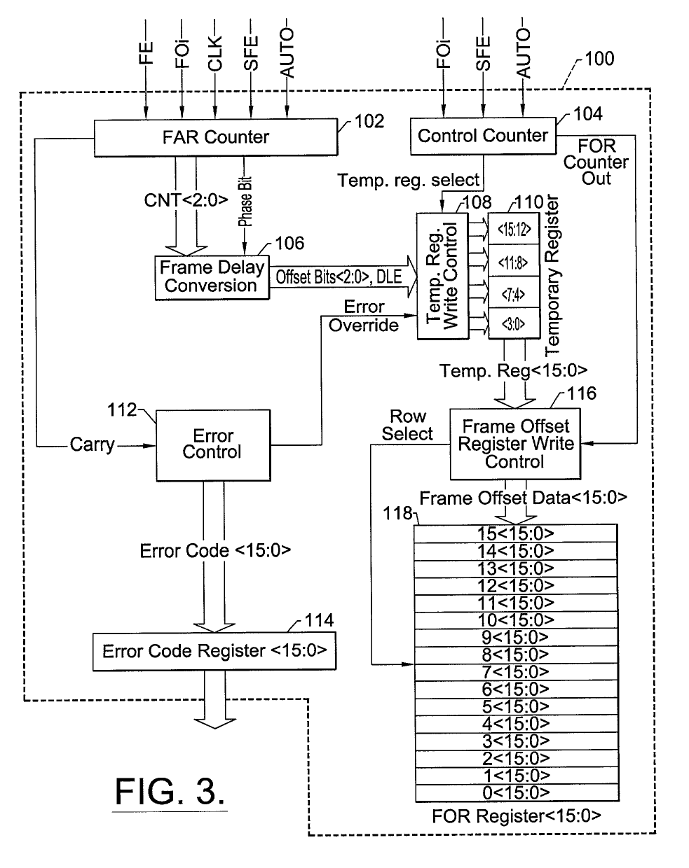

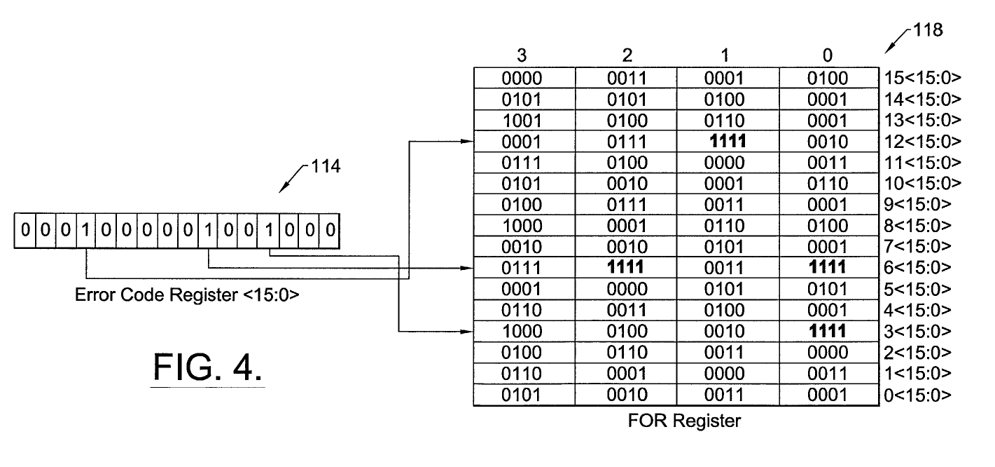

Referring now to FIGS. 3-4, time-slot interchange switches 100 according to preferred embodiments of the present invention comprise an internal frame alignment counter 102 and a frame delay conversion circuit 106. The internal frame alignment counter 102 may be responsive to a frame evaluation signal (FE), a start frame evaluation signal (SFE), a frame output indicator signal (FOi), an external clock signal (CLK) and an auto signal (AUTO) which may be used to commence a preferred automatic frame offset measurement cycle. Backward compatibility may also be available to enable manual frame offset measurement, as described above with respect to FIGS. 1-2. As will be understood by those skilled in the art, setting the start frame evaluation signal (SFE) low for at least one frame can commence a measurement cycle in a manual frame measurement mode. However, in an automatic measurement mode (AUTO=1), setting SFE high prior to receipt of an FOi can be performed to automatically reset and align the internal frame alignment counter. Once the internal frame alignment counter 102 has been aligned to the frame output indicator signal FOi, counting continues until a frame evaluation (FE) pulse for a corresponding multi-frame data stream is received. The delays associated with receiving a frame evaluation (FE) pulse from an external serial device may be caused by variable path lengths and variable path serial backplanes, which are typical in large centralized and distributed switching systems.

The value of the frame alignment counter 102, which typically equals the number of clock pulses between FOi and FE, as well as a bit indicating the phase of the external clock (CLK), is then passed to the frame delay conversion circuit 106. As illustrated by FIG. 3, the value of the counter 102 may be expressed in three bits (CNT<2:0>) and the clock phase bit may constitute a fourth bit of a four (4) bit byte. The three bits may be expressed as the frame delay bits FD0-FD2 illustrated by FIG. 2, with the phase bit expressed as FD11. These counting operations are preferably performed to automatically and sequentially measure a plurality of stream offsets. Accordingly, a time-slot interchange switch capable of automatically handing sixty four (64) multi-frame data streams may generate 64×4=256 frame delay bits in response to commencement of an automatic frame offset measurement cycle. The preferred time-slot switches 100 may also include circuitry for storing a data bit value (or reassigning or resetting a value of a data bit) to indicate to the user that the automatic measurement mode is complete.

The frame alignment counter 102 may also generate an error signal in the event a delay associated with a respective multi-frame data stream received by the switch 100 exceeds a maximum rated offset value. Thus, if the maximum rated offset value is 4.5 clock cycles, as illustrated by FIG. 2, then the error signal may be generated by the counter 102 as a carry signal once the counter 102 has counted up to five (5) clock cycles. Thus, the error signal may be generated when the boolean AND of CNT<0> and CNT<2> first transitions from 0→1 during a count up sequence by the counter 102.

A frame delay conversion circuit 106 is also provided to generate frame offsets. As illustrated by FIG. 3, the frame delay conversion circuit 106 may receive three (3) count bits (CNT<2:0>) and one phase bit from the frame alignment counter 102. The combination of the phase bit and the three count bits may be treated as a frame delay byte, with the phase bit constituting the most significant bit therein. The frame delay conversion circuit 106 may perform a bit swap operation by inverting the value of the phase bit and moving the placement of the inverted phase bit from the most significant bit location to the least significant bit location. Thus, as illustrated by FIG. 2, an inverted value of the phase bit FD11 within a frame delay byte may be treated as the least significant bit DLEn of a four bit frame offset byte. If 4.5 clock cycles is the maximum acceptable frame offset at a rated speed of operation, for example, the range of acceptable frame offsets may extend from a value indicating no offset (i.e., {OFn2, OFn2, OFnO, DLEn}=0000) to a maximum acceptable offset of 4.5 clock cycles (i.e., {OFn2, OFn2, OFn0, DLEn}=1001). The frame delay conversion circuit 106 may also generate unacceptable frame offsets outside the ten acceptable values in the range from 0000 to 1001. These acceptable frame offsets (and possibly the unacceptable frame offsets in the remaining range from 1010 to 1111) are preferably written into an internal temporary register 110 using a temporary register write control circuit 108. This temporary register write control circuit 108 is preferably responsive to a temporary register select signal that may be generated by a control counter 104.

As illustrated, the control counter 104 may be responsive to the start frame evaluation signal (SFE), the frame output indicator (FOi) signal and the AUTO signal. The temporary register select signal generated by the control counter 104 may be used to initiate sequential transfer of each frame offset into a respective portion of the temporary register 110 or groups of four frame offsets may be accumulated and written into the temporary register 110 in parallel after each respective group of four multi-frame data streams has been measured. For a time-slot interchange switch capable of handling 64 multi-frame data streams, sixty four (64) writing operations may be performed to write frame offset data into the temporary register 110 during an automatic measurement cycle. The control counter 104 may also generate a frame offset register (FOR) counter out signal as a synchronization signal. This synchronization signal controls transfer of the contents of the temporary register 110 to a respective row within a frame offset register (FOR) 118. As illustrated, frame offset register write control circuitry 116 is provided for controlling the writing of data from within the temporary register 110 to the frame offset register 118. The write control circuitry 116 may also generate a row select signal (or register select signal) which is incremented after each operation to write frame offset data into the frame offset register 118.

An error control circuit 112 is also provided that preferably generates an error code and an error override signal. The value of the error code may depend on the values of a plurality of error signals (i.e., carry signals) generated by the frame alignment counter 102. The error code may be stored within an error code register (ECR) 114 using conventional techniques. The error code within the error code register 114 is preferably accessible by a user of the time-slot interchange switch 100. According to a preferred aspect of this embodiment, the error control circuit 112 may generate an error code having a reduced number of bits relative to the rated number of multi-frame data streams the time-slot switch 100 is capable of handling. For example, if the rated number of multi-frame data streams the switch 100 is capable of handling is 64, the error code may be a 16 bit error code, with each bit of the error code being used to designate whether at least one of a possible four frame offsets within a row of the frame offset register (FOR) 118 is unacceptable. For example, as illustrated by FIG. 4, an error code having a value equal to {0001000001001000} may be used to designate that rows 3, 6 and 12 within the frame offset register 118 contain unacceptable frame offsets. These unacceptable frame offsets (shown as four (4)) are illustrated in bold as having the value 1111 for easy detection by a user (however, other values within the range of 1010 to 1111 may also be used). This erroneous or unacceptable value of 1111 may be provided by the temporary register write control circuit 108 in the event an override signal (e.g., ERROR OVERRIDE=1) is generated by the error control circuit 112 and provided to the temporary register write control circuit 108, upon receipt of a carry signal generated by the frame alignment counter 102. Alternatively, the frame delay conversion circuit 106 may include circuitry therein to generate an unacceptable value of 1111 in the event any delay value greater than the rated maximum delay value is received from the frame alignment counter 102. In larger designs, the error code register 114 may have fewer storage units therein relative to the number of rows in the frame offset registers (FOR) 118. In this case, each bit of the error code may identify presence of an unacceptable frame offset in a respective plurality of rows of the frame offset register (FOR) 118.

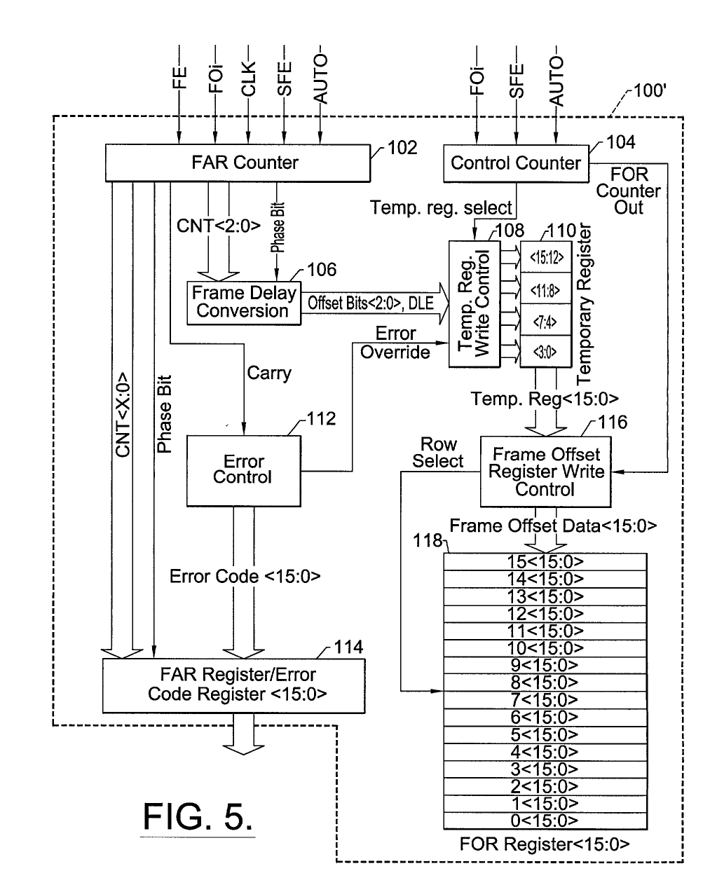

Referring now to FIG. 5, a time-slot interchange switch 100′ according to a second embodiment of the present invention is illustrated. This switch 100′ is similar to the switch 100 of FIG. 3, however the error code register 114 also functions as a frame alignment register that may be used when performing manual measurements to determine frame delays associated with one or more multi-frame data streams. In particular, selected manual measurements may be performed following an automatic measurement of all multi-frame data streams received by the switch 100′. In those cases where the above-described automatic measurement operations result in an error code register 114 having data that indicates the presence of one or more unacceptable frame offsets within the frame offset register 118, manual measurement operations may be performed on those multi-frame data streams identified as having unacceptable frame delays or frame offsets. Rather than being limited to three bits of delay information with one bit of phase information, as received by the delay conversion circuit 106 during an automatic frame alignment measurement operation, a multi-bit count signal CNT<X:0> having a potentially greater width may be used to more accurately measure frame delays that exceed those illustrated by FIG. 2. For example, the frame alignment counter 102 may be an eleven (11) bit counter and may be capable of generating an eleven bit count signal (CNT<10:0>) and one phase bit. As illustrated, this expanded count signal and phase bit may be provided directly to a frame alignment register/error code register 114 during a manual measurement mode, for example. The switch user may then accurately determine higher frame delay/frame offsets by reading out and decoding the count signal and phase bit from the frame alignment register/error code register 114. Thus, a multi-frame input stream that is delayed by an excessive amount, relative to the rating of the time-slot interchange switch, may initially be detected when the error code register 114 and possibly the frame offset register 118 are read out upon completion of an automatic frame alignment measurement mode. A more accurate assessment of delay can then be made during subsequent manual measurement by loading the multi-bit count signal (CNT<X:0>) and phase bit from the frame alignment counter 102 directly into the error code register 114 and then reading out and decoding the count signal and phase bit. In this manner, the error code register 114 may perform separate functions during automatic and manual measurement modes.

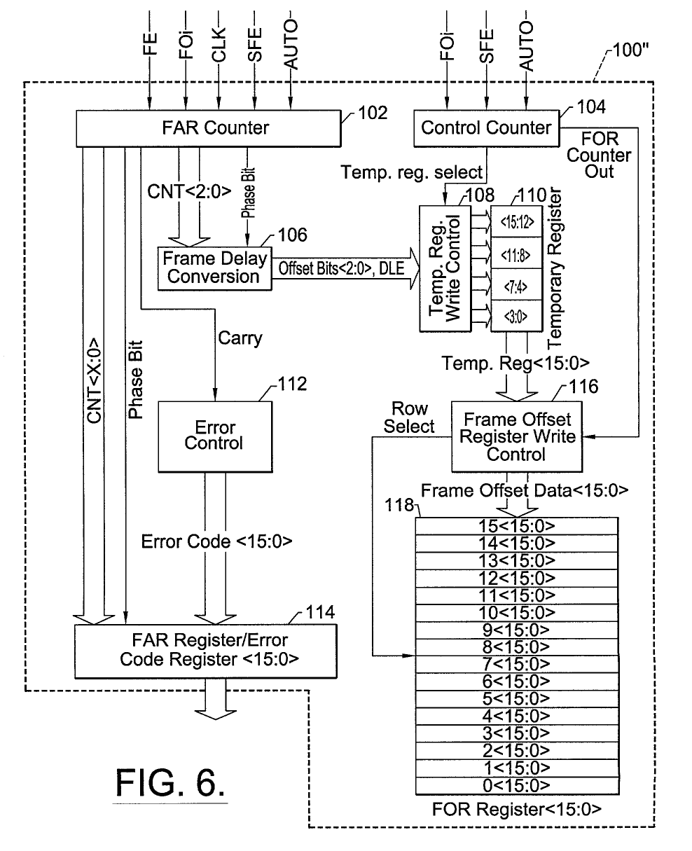

Referring now to FIG. 6, a time-slot interchange switch 100″ according to another embodiment of the present invention is similar to the switch 100′ of FIG. 5, however, the error control circuitry 112 is not illustrated as providing an override of an unacceptable frame offset (e.g., 1111) into the temporary register write control circuit 108, upon receipt of an error signal (e.g., carry signal) from the frame alignment counter 102. According to this embodiment, the frame delay conversion circuit 106 may provide unacceptable offsets as offsets outside the range indicated in the table of FIG. 2, with the value 1111 being used for frame offsets that are greater than or equal to 7.5 clock cycles:

| Frame Offset Value | Delay (Clock cycles) |
|---|---|
| 1010 | 5 |
| 1011 | 5.5 |
| 1100 | 6 |
| 1101 | 6.5 |
| 1110 | 7 |
| 1111 | ≧7.5 |

Nonetheless, like the embodiment of FIGS. 3 and 5, the error code register 114 of FIG. 6 can still be used to identify whether any of the unacceptable frame offsets in the range from 1010 to 1111 are present in the frame offset register 118.

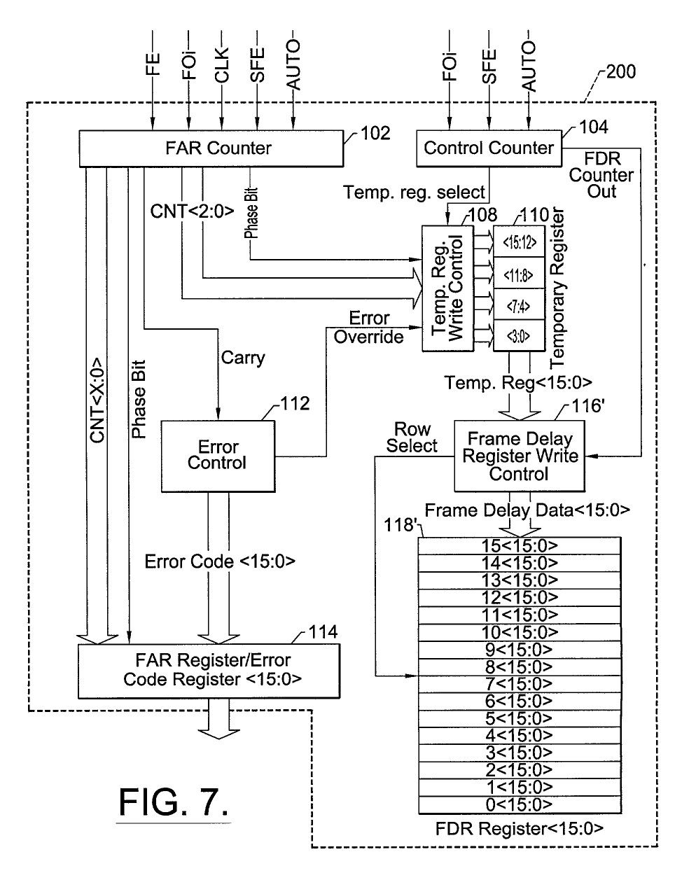

As illustrated by the time-slot interchange switch 200 embodiment of FIG. 7, the frame delay conversion circuitry 106 may be omitted altogether and the frame delay information may be provided directly to the temporary register 110. In this embodiment, a frame delay register 118′ may be provided to store acceptable and unacceptable frame delays. Write control into this frame delay register 118′ may be provided by a frame delay register write control circuit 116′.

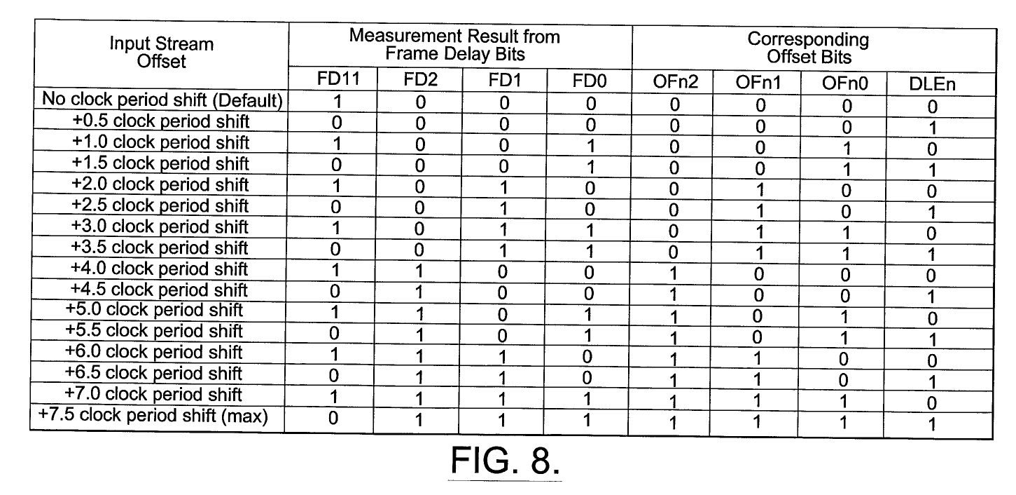

Referring now to FIGS. 3-4 and 8, time-slot interchange switches 100 may be capable of handling frame offsets greater than 4.5 clock cycles, without requiring a CNT signal having greater than 3 bits. For example, in the event the switches 100 are capable of maximum frame offsets of 7.5 clock cycles, the carry signal generated by the internal frame alignment counter 102 may be generated when the count bit CNT<3> transitions from 0→1. According to this embodiment, the temporary register write control circuit 108 may generate a frame offset value of 1111 (to be stored in the temporary register 110) in the event a frame delay of greater than 7.5 clock cycles is detected and the error control circuit 112 generates an override signal. Because this frame offset value of 1111 also corresponds to the largest acceptable frame offset, as illustrated by the last row in the table of FIG. 8, manual operations may need to be performed by a user in the event an error bit within the error code register 114 designates the presence of an error within a respective row of the frame offset register 118 and the designated row has more than one byte having an offset value of 1111. For example, if an error code having a value equal to {0001000001001000} is present in the error code register 114 and the data within the frame offset register 118 is as illustrated by FIG. 4, then a manual measurement will typically need to be performed to determine whether one or more of the serial data streams corresponding to columns 0 and 2 of row 6 of the frame offset register 118 are out of synchronization by more than 7.5 clock cycles.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A time-slot interchange switch, comprising:
an internal frame alignment measurement and programming circuit that determines and stores a first frame offset associated with a first multi-frame data stream received by said switch in a frame offset register, and at least temporarily retains data that identifies presence of an unacceptable frame offset in the internal frame offset register.

2. The switch of claim 1, wherein said internal frame alignment measurement and programming circuit comprises an error code register that retains the data; and wherein the data is accessible by a user.

3. The switch of claim 1, wherein said internal frame alignment measurement and programming circuit comprises:
an internal frame alignment counter that determines a first frame delay associated with the first multi-frame data stream; and
an internal frame delay conversion circuit that converts the first frame delay into the first frame offset.

4. The switch of claim 2, wherein said internal frame alignment measurement and programming circuit comprises:
an internal frame alignment counter that determines a first frame delay associated with the first multi-frame data stream; and
an internal frame delay conversion circuit that converts the first frame delay into the first frame offset.

5. The switch of claim 4, wherein said frame offset register retains the first frame offset at a first location therein; and wherein said error code register retains a pointer having a value that indicates whether an unacceptable frame offset is present at the first location.

6. The switch of claim 2, wherein said frame offset register retains the first frame offset at a first location therein; and wherein said error code register retains a pointer having a value that indicates whether an unacceptable frame offset is present at the first location.

7. The switch of claim 6, wherein said frame offset register retains M rows of frame offset data with N frame offset bytes per row; wherein said error code register retains an M-bit error code; and wherein each bit in the M-bit error code identifies whether at least one of the N frame offset bytes at a corresponding row in said frame offset register is an unacceptable frame offset.

8. The switch of claim 7, wherein said frame offset register retains n×M rows of frame offset data with N frame offset bytes per row, where n is a nonzero integer; wherein said error code register retains an M-bit error code; and wherein each bit in the M-bit error code identifies whether at least one of the N frame offset bytes at a corresponding row or rows in said frame offset register is an unacceptable frame offset.

9. The switch of claim 4, wherein said switch is responsive to a clock signal; and wherein said internal frame alignment counter generates an error signal if the first frame delay is not less than a threshold number of cycles of the clock signal.

10. The switch of claim 9, wherein said internal frame alignment measurement and programming circuit comprises:
a temporary register that receives frame offsets from said internal frame delay conversion circuit; and
an error control circuit that provides an unacceptable frame offset to said temporary register and is responsive to the error signal.

11. The switch of claim 10, wherein said internal frame alignment measurement and programming circuit comprises:
a frame offset register control circuit that writes the unacceptable frame offset from said temporary register into said frame offset register.

12. The switch of claim 11, wherein said error control circuit generates the data that is received by said error code register.

13. A time-slot interchange switch, comprising:
an internal frame alignment measurement and programming circuit that determines and then stores a plurality of acceptable frame offsets associated with a first plurality of multi-frame data streams received by said switch and determines and then stores an unacceptable frame offset associated with a multi-frame data stream having an offset that exceeds a maximum offset rating of said switch.

14. The switch of claim 13, wherein the plurality of acceptable frame offsets and the unacceptable frame offset are stored within a frame offset register.

15. The switch of claim 14, wherein said internal frame alignment measurement and programming circuit retains user accessible data that identifies presence of the unacceptable frame offset in the internal frame offset register.

16. A time-slot interchange switch, comprising:
a first storage device that is disposed internal to said switch and retains frame delay/offset bytes, with each of the frame offset/delay bytes identifying a frame delay or frame offset associated with a respective multi-frame data stream received by said switch; and
a second storage device that is disposed internal to said switch and at least temporarily retains data that identifies presence of an unacceptable frame delay/offset within said first storage device.

17. The switch of claim 16, wherein the data identifies presence and location of the unacceptable frame delay/offset within said first storage device.

18. The switch of claim 16, wherein said first storage device is a register having M rows of storage units therein; and wherein said second storage device retains an M-bit error code therein.

19. A time-slot interchange switch, comprising:
a frame alignment counter that determines a respective frame delay for each of a plurality of multi-frame data streams received by said switch and generates an error signal if any of the frame delays is excessive;
a frame delay conversion circuit that converts the frame delays to acceptable frame offsets;
an error control circuit that generates an error code and an unacceptable frame offset and is responsive to the error signal;
a temporary register that stores the acceptable frame offsets and the unacceptable frame offset received from said frame delay conversion circuit and said error control circuit, respectively;
a frame offset register
a control circuit that writes the acceptable frame offsets and the unacceptable frame offset from said temporary register to a row within said frame offset register; and
an error control register that stores the error code.

20. The switch of claim 19, wherein the error signal is a carry signal; wherein the error code is an M-bit error code; wherein said frame offset register has M rows therein; and wherein each bit of the M-bit error code within said error control register identifies whether an unacceptable frame offset is stored within a respective row of said frame offset register.

21. A time slot interchange switch, comprising:
an internal frame alignment measurement circuit that determines a first frame offset associated with a first multi-frame data stream received by said switch;
an internal frame offset register that retains the first frame offset at a first location therein; and
an internal error code register that retains a pointer having a value that indicates whether an unacceptable frame offset is present in said internal frame offset register.

22. The switch of claim 21, wherein said internal frame alignment measurement circuit comprises:
a counter that determines a first frame delay associated with the first multi-frame data stream; and
an internal frame delay conversion circuit that converts the first frame delay into the first frame offset.

23. A method of operating a time slot interchange switch, comprising the steps of:
measuring a first frame offset associated with a first multi-frame data stream received by the switch and then storing the measured first frame offset as an acceptable or unacceptable frame offset in a frame offset register; and
generating, internal to the switch, user accessible data that identifies presence of an unacceptable frame offset in the frame offset register.

24. The method of claim 23, wherein said generating step comprises generating the user accessible data as an error code that is retained within an error code register.

25. The method of claim 24, wherein said generating step is followed by the steps of:
measuring a first frame delay associated with the first multi-frame data stream as a multi-bit frame delay; and
writing the multi-bit frame delay into the error code register with the multi-bit frame delay.

26. The method of claim 25, wherein a number of bits in the multi-bit frame delay is greater than the number of bits in the first frame offset.
